(19) United States
(12) Patent Application Publication
(10) Pub. No.: US 2002/0100725 A1
(43) Pub. Date: Aug. 1, 2002

(54) Method for preparing thin fiber-structured polymer web

(76) Inventors: Wha Seop Lee, Seoul (KR); Seong Mu Jo, Seoul (KR); Suk Won Chun, Seoul (KR); Sung Won Choi, Kyungki-do (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 10/014,550

(22) Filed: Dec. 14, 2001

(30) Foreign Application Priority Data
Jan. 26, 2001 (KR) 2001-3685

(51) Int. Cl. B01D 39/08

(52) U.S. Cl. 210/503; 210/505; 428/98; 264/413

(57) ABSTRACT

Disclosed is a method for preparing a thin fiber-structured polymer web suitable for a high-speed and large-scale production using electrospinning.

The method uses an electrospinning process to spin a solution containing a polymer in a volatile solvent to obtain a thin fiber-structured polymer web on a collector, in which case the temperature of the polymer solution is in the range of from 40° C. to the boiling point of the solvent. The porous, thin fiber-structured polymer web thus obtained is applicable to the isolation layer or the electrolytic layer for lithium-ion secondary battery, lithium-metal secondary battery or sulfur-based secondary battery, the isolation layer for fuel cells, filter, and so forth.

### BACKGROUND OF THE INVENTION

1. Field of the Invention

The present invention relates to a method for preparing a thin fiber-structured polymer web, and more particularly, to a method for preparing a thin fiber-structured polymer web suitable for a high-speed and large-scale production using electrospinning.

2. Description of the Background Art

The thin or ultra-thin fiber-structured polymer web is used for the isolation layer or the electrolytic layer for lithium-ion secondary battery, lithium-metal secondary battery or sulfur-based secondary battery, the isolation layer for fuel cells, filter, wound dressing, medical barrier web, medical scaffolder, sensors for MEMS/NEMS (micro- or nanoelectrical mechanical and optical systems, and so forth. If carbonated or graphitized, the polymer web can also be used as a material for electrode materials, hydrogen storage medium, or the like.

The conventional fiber fabrication technology, i.e., melt spinning, web spinning, dry spinning, or dry jet-wet spinning involves extrusion of a polymer melt or solution through a nozzle by the mechanical force and solidification of it to fabricate fibers. The conventional fiber fabrication technology may produce fibers having a diameter of from several micrometers to several scores of micrometers and the current ultra-thin technology may produce ultra-thin fibers having a diameter of from several sub-microns to several micrometers. But, those technologies have a problem in regard to limitation of polymers applicable and an extremely complicated process in case of using a method of melting part of the fibers.

Conventionally, there has been used a process of spraying a liquid or powder using the static air pressure and applying a high voltage to achieve a high coating efficiency and uniform coatings for the sake of a higher efficiency. This process is carried out through the discharge of fine particles (mostly having a diameter of several micrometers) and includes an electro-coating process, a powder coating and pesticide application process, or a cold oiler process. The material used for the process is usually a liquid organic material or a powder having a low molecular weight. The liquid material is mostly of a low viscosity and, if having a high viscosity, it is not a polymer but an organic material that hardly has spinnability.

On the basis of this principle, polymers have been recently applied to the fiber fabrication process and the “electrospinning” differentiated from the conventional process has also been used in recent years, since it is known that the use of polymers may produce a fiber having a diameter of several nanometers owing to the reological characteristic of the polymers.

The electrospinning is recently reported to be applicable to polymers of various forms, such as polymer melt, polymer solution or the like and produce a fiber having a diameter of several nanometers. Such a small-diameter fiber has a large specific surface area relative to the existing fibers, enables to produce a polymer web having a high porosity and provides new properties that are impossible to realize in the existing products. Also, the electrospinning is a process for fabricating a polymer web directly from a liquid with a low complexity.

The related reports are “Electrospinning Process and Applications of Electrospun Fibers” by Doshi and Reneker (J. Electrostatics, 35, 151-160 (1995), “Beaded nanofibers formed during electrospinning” by H. Fong (Polymer, 40, 4585-4592 (1999)) and “Transparent Nanocomposites with Ultrathin, Electrospun Nylon-4,6 Fiber Reinforcement” by Michel M. Bergshoef et al. (Adv. Mater., 11, 16, 1362-1365 (1999)), which suggests the fibers as a composite material. U.S. Pat. No. 6,106,913 by Frank et al. discloses a combination of electrospinning and air vortex spinning to produce fibers having a diameter of 1 nm at 4 Å for use in the yarn fabrication. U.S. Pat. No. 6,110,590 describes a fabrication of biodegradable silk having a diameter of 2 to 2,000 nm using electrospinning. Also, PCT/KR00/00500, PCT/KR00/00498, PCT/KR00/00501 and PCT/KR00/00499 by the present inventor disclose an isolation layer and an electrolytic layer produced by electrospinning, and a method for fabricating a lithium secondary battery using the same.

In a process for fabricating a porous polymer web using electrospinning, the polymer solution is extruded through fine holes under electric field to volatilize or solidify the solvent from the solution and thereby form fibers on the surface of a collector located in the lower end at a predetermined distance. The polymer web thus obtained is a laminated three-dimensional network structure of fibers having a diameter of from several nanometers to several thousands of nanometers and has a very large surface area per unit volume. Accordingly, the polymer web is superior in porosity and specific surface area to those produced by the other fabrication methods.

The process involves conversion of a solution to a solid polymer web and thus reduces the required time for fabrication with a very low complexity and a high economic efficiency. Also, the process enables to readily control the diameter (i.e., from several nanometers to several thousands of nanometers) of fibers in the polymer web, the thickness (i.e., from several micrometers to several thousands of micrometers) of the layer and the size of the pores by modifying the process conditions and, if necessary, to produce a porous polymer web having a different shape and thickness.

The phenomenon that takes place when applying a high voltage to the liquid drops hanging on an orifice in the electrospinning process is called “Taylor cone”, which is well studied. In this phenomenon, a stream is formed to discharge the liquid drop towards the collector when the force of charges exceeds the surface tension of a solution to be hung. An organic solution having a low molecular weight can be sprayed into fine liquid drops. But, a polymer solution forms a stream due to its high viscosity and rheological characteristic and the stream is split into several sub-streams with densely accumulated charges as it becomes apart from the Taylor cone to reduce the diameter. The large surface area of the polymer solution that increases in geometric progression accelerates solidification of the polymer solution and volatilization of the solvent, forming a polymer web with entangled solid fibers on the surface of the collector. It is general that the required time for the polymer solution to move from the orifice or nozzle to the collector and form solid fibers is shorter than one second, normally 0.1 to 0.01 second.

A great increase in the discharged amount without raising the applied voltage results in liquid drops rather than fibers or a polymer web in which fibers are mixed with liquid drops. An extremely high voltage makes the discharged polymer stream unstable and uncontrollable. It is thus of a great importance to work in conditions for applying a voltage of an appropriate level.

A rise of the applied voltage or an increase in the discharged amount increases the diameter of the stream emitted from the Taylor cone to form a polymer with fibers having a large diameter. The electrospinning process that produces such thick fibers is disadvantageous in the aspect of productivity over the conventional fiber fabrication methods using the spinning technology.

In addition, the electrospinning process largely depends on the force of charges and is thus disadvantage in large-scale production over the conventional fiber fabrication processes, because the discharged amount from the nozzle is relatively small in production of a polymer web with fibers having a small diameter compared with the case of the conventional processes.

For large-scale production or high-speed production of a polymer web using the electrospinning process, a plurality of nozzles or orifices for discharging the polymer solution are densely arranged in a small space, making it difficult to volatilize the solvent of the polymer solution. As a result, there is a high possibility to form a polymer web having a film structure rather than a fiber structure, which problem is a serious obstacle to high-speed or large-scale production of the polymer web using the electrospinning process.

In the aspect of higher productivity of the polymer web, it is favorable to increase the discharged amount of the polymer solution from each nozzle or orifice or the number of nozzles or orifices. However, such a simple increase in the discharged amount may result in formation of liquid drops or a polymer web in which fibers are mixed with liquid drops.

The inventors of the present invention have directed to the present invention on the basis of the conception that a high-quality fiber-structured polymer web having a desired thickness can be produced with a larger discharged amount but without thickening the constitute fibers, by increasing the volatility of the solvent to rapidly reduce the diameter of the stream even though the initial stream in the Taylor cone is large in diameter, or decreasing the viscosity of the polymer solution within the range that the concentration of the polymer is not highly lowered.

### SUMMARY OF THE INVENTION

Accordingly, the present invention is directed to a method for preparing a thin fiber-structured polymer web that substantially obviates one or more problems due to limitations and disadvantages of the related art.

An object of the present invention is to solve the problem with the conventional method for preparing a porous polymer web by the electrospinning process in regard to large-scale production that is an obstacle to the commercial use, and to provide a novel method for preparing a thin fiber-structured polymer web through a high-speed or large-scale production.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof.

To achieve these objects and other advantages and in accordance with the purpose of the invention, as embodied and broadly described herein, there is provided a method for preparing a thin fiber-structured polymer web that includes the steps of: dissolving a polymer in a volatile solvent used as a polymer solvent to prepare a polymer solution; spinning the polymer solution by electrospinning; and forming a thin fiber-structured polymer web cumulated on a collector.

According to the present invention, a polymer is dissolved in a solvent and the resulting solution is converted to a solid by electrospinning, thereby producing a porous web of a high porosity.

For a high-speed and large-scale production of the polymer web according to the present invention, the polymer solution used in the electrospinning process is prepared by adding a solvent in which the polymer is soluble, and dissolving the polymer in the solvent.

The use of a solvent having a high volatility may enhance the productivity. In this case, the volatility of the solvent as used herein increases as one stream emitted from the Taylor cone is split into several streams with a surface area increasing in geometric progression. Even though the stream initially emitted from the Taylor cone has a large diameter, an increase in the volatility of the solvent may rapidly reduce the diameter of the stream to enhance the productivity and produce a high-quality polymer web having a fiber structure with a desired thickness.

A rise of the temperature of the polymer solution discharged reduces the viscosity of he polymer solution and enhance the volatility of the solvent to achieve a higher productivity.

In consideration of the boiling point of the solvent used to dissolve the polymer, the temperature of the polymer solution is properly in the range from 40° C. to the boiling point of the solvent, preferably from 40 to 180° C. The warming method available herein may include the use of a heating band, an oil jacket, or a hot blast heater.

If the temperature of the polymer solution during the process exceeds the boiling point of the solvent used to dissolve the polymer, the viscosity of the polymer solution rapidly increases with bubbles to make the discharge rate of the polymer solution not uniform and the normal working impossible. When a high-volatility solvent is not used at a temperature below 40° C., a rapid rise of the volatility cannot be achieved so that there forms a polymer web having a film or fiber structure mixed with liquid drops.

The polymer available in the electrospinning of the present invention may include various polymers capable of being melted or soluble in a proper solvent, such as poly(vinylidene fluoride (PVDF), poly(vinylidene fluoride-co-hexafluoropropylene), polyacrylonitrile, poly(acrylonitrile-co-methacrylate), polymethylmethacrylate, polyvinylchloride, poly(vinylidenechloride-co-acrylate), polyethylene, polypropylene, nylons (e.g., nylon12 or nylon-4,6), biodegradable polymers (e.g., aramid, polybenzimidazole, polyvinylalcohol, cellulose, cellulose acetate, cellulose acetate butylate, polyvinyl pyrrolidone-vinyl acetates, poly(bis-(2-(2-methoxy-ethoxyethoxy))phosphazene (MEEP), poly(propyleneoxide), poly(ethylene imide) (PEI), poly(ethylene succinate), polyaniline, poly(ethylene sulphide), poly(oxymethylene-oligo-oxyethylene), SBS copolymer, poly(hydroxy butyrate), poly(vinyl acetate), poly(ethylene terephthalate), poly(ethylene oxide), collagen, poly(lactic acid), poly(glycolic acid), poly(D,L-lactic-co-glycolic acid), polyarylates, poly(propylene fumalates) or poly(caprolactone)), biopolymer (e.g., polypeptide or protein), or pitches (e.g., coal-tar pitch or petroleum pitch), or copolymers or blends of them.

Besides, the polymer may be mixed with an emulsion or an organic or inorganic powder.

Examples of the solvent as used in the present invention may include:

(a) a high-volatility solvent group, including acetone, chloroform, ethanol, isopropanol, methanol, toluene, tetrahydrofuran, water, benzene, benzyl alcohol, 1,4-dioxane, propanol, carbon tetrachloride, cyclohexane, cyclohexanone, methylene chloride, phenol, pyridine, trichloroethane or acetic acid; or

(b) a relatively low-volatile solvent group, including N,N-dimethyl formamide (DMF), dimethyl sulfoxide (DMSO), N,N-dimethylacetamide (DMAc), 1-methyl-2-pyrrolidone (NMP), ethylene carbonate (EC), propylene carbonate (PC), dimethyl carbonate (DMC), acetonitrile (AN), N-methylmorpholine-N-oxide, butylene carbonate (BC), 1,4-butyrolactone (BL), diethyl carbonate (DEC), diethylether (DEE), 1,2-dimethoxyethane (DME), 1,3-dimethyl-2-imidazolidinone (DMI), 1,3-dioxolane (DOL), ethyl methyl carbonate (EMC), methyl formate (MF), 3-methyloxazolidin-2-on (MO), methyl propionate (MP), 2-methyletetrahydrofurane (MeTHF) or sulpholane (SL).

Preferably, the solvent to dissolve the polymer is the above-mentioned high-volatility solvent, or a mixed solvent comprising a high-volatility solvent and a relatively low-volatility solvent, the use of which solvent may increase the volatility of the solvent or lower the viscosity of the solution to increase the discharged amount from the individual nozzles and thereby enhance the productivity.

Namely, one of the above-mentioned polymers is mixed with a solvent that comprises at least one solvent selected from the group (a), or with a mixed solvent that comprises at least one solvent selected from the group (a) and at least one solvent selected from the group (b). The resulting solution is then heated with stirring to prepare a clear polymer solution, which is used in the electrospinning device to produce a polymer web through a high-speed or large-scale production.

For large-scale production of the polymer web by the electrospinning process, the relative humidity in a working space for the electrospinning is preferably in the range from 0 to 40%. The humidity means the content of moisture in the atmosphere and the moisture acts as a nonsolvent for the polymer. Accordingly, with the relative humidity exceeding 40%, the surface of the stream emitted from the Taylor cone rapidly solidifies to suppress the split of the stream and hence the stretching of it into the fiber structure, as a result of which granule liquid drops are discharged.

The content of the polymer used in the preparation of the polymer solution is preferably in the range from 0.1 to 40 wt. % based on the content of the solvent. When the content of the polymer exceeds 40 wt. %, the viscosity of the polymer solution is too high to form a stream by the electrical force. With the content of the polymer less than 0.1 wt. %, an extremely low viscosity of the polymer solution results in formation of liquid drops for a polymer having a low molecular weight; and the productivity becomes low for a polymer having a high molecular weight.

To remove the solvent volatilized as the polymer solution solidifies by the electrospinning, the working space may be equipped with an air vent for ventilation, or air knives or an air curtain may be provided around the nozzles or orifices or beside the collector, to allow entrance of air and compulsory discharge of the air containing a large amount of the volatilized solvent through the air vent for more volatilization of the solvent.

The thickness of the polymer web according to the present invention is controllable in the range from 1 to 100 μm.

The electrospinning process as a method for preparing a polymer web composed of at least one polymer may be classified into two methods: the one method is spinning a polymer solution containing different polymers through more than one nozzle to prepare a porous polymer web in which the polymers are completely mixed; and the other is adding the individual polymer solutions into the respective barrels of the electrospinning device and simultaneously spinning them through the individual nozzles to prepare a high-porosity polymer web in which polymer fibers are entangled with one another.

The porous, thin fiber-structured polymer web of the present invention thus obtained is useful for used for the isolation layer or the electrolytic layer for lithium-ion secondary battery, lithium-metal secondary battery or sulfur-based secondary battery, the isolation layer for fuel cells, filter, wound dressing, medical barrier web, medical scaffolder, sensors for MEMS/NEMS (micro- or nanoelectrical mechanical and optical systems, and so forth. If carbonated or graphitized, the polymer web can also be used as a material for electrode materials, hydrogen storage medium, or the like.

For the collector used to collect the polymer web cumulated in the electrospinning process, any conductive material can be used. A cumulation plate is placed on the conductive collector in order to cumulate the polymer web on a non-conductor. If available, charges opposite to those on the nozzles may be provided as a collector.

The collector can have any shape, such as flat panel, porous plate, or web, which characteristic of the collector allows various applications. Accordingly, the porous fiber-structured polymer web of the present invention can be used in applications directly cumulated on a conductive material used as a collector, or in applications using a layer-type collector for a single polymer web.

The present invention method that prepares a polymer web used as an isolation layer for lithium secondary battery enables to prepare a layer having effective air pores for entrance of electrolyte due to a structure destitute of closed air pores, with laminated fibers having a diameter of from several nanometers to several thousands of nanometers. For such a layer, the pores formed in the lamination process are not closed in the course of battery assemblage. Also, the present invention method does not use a pore-forming agent that is used in the existing battery preparation process of Bell Core Co., Ltd., and has no deterioration of the performance of the battery that may otherwise be caused by the pore-forming agent remaining after the preparation process.

When used as an electrolyte layer for lithium secondary battery, the polymer web prepared by the present invention method can be produced as a high-porosity electrolyte layer directly on the surface of the electrodes for lithium secondary battery, which case greatly reduces the interface resistance at the electrode. More specifically, the polymer web can be coated directly on the surface of the electrodes to simplify the process, the electrodes including: an anode comprising at least one selected from the group consisting of LiCoO₂, LiMn₂O₂, LiMn₂O₄, LiNiO₂, LiCrO₂, LiVO₂, LiFeO₂, LiTiO₂, LiScO₂, LiYO₂, LiNiVO₄ LiNiCoO₂, V₂O₅ and V₆O₁₃; or a cathode comprising at least one selected from the group consisting of a carbon material including graphite, cokes or hard carbon, tin oxide, lithium compound of these materials, metal lithium and metal lithium alloy. In such a manner, the polymer web is superior in mechanical properties to the layer prepared by the solvent casting method having the same air pores, because the polymer has a multi-dimensional structure composed of fibers having a diameter of from several nanometers to several thousands of nanometers.

Besides, the present invention enables to directly laminate the polymer web on a sulfur-based anode and use it for sulfur-based batteries. The anode material of the sulfur-based battery is usually an organosulfide compound, examples of which may include 2,5-dimercapto-1,3,4-thiadiazole (C₂N₂S(SH)₂, DMcT), HSCH₂CH₂SH (DTG), s-triazine-2,4,6-trithiol (C₃H₃N₃S₃, TTA), 7-methyl-2,6,8-trimercaptopurine (C₆H₆N₄S₃, MTMP), or 4,5-diamino-2,6-dimercaptopyrimidine (C₄H₆N₄S₂, DDPy).

More specifically, the collector can be an anode (e.g., a DMcT-polyaniline-polypyrrole-copper electrode) comprising a polycarbon sulfide of (SRS)n in which R is carbon, or an organodisulfide composite compound containing polyaniline added to the polycarbon sulfide; an anode (e.g., a DMcT anode or a mixed anode of DMcT and polyaniline) comprising an organodisulfide compound represented in a charged state by the formula of [(R(S)y)n] in which y is 2 to 6; n is greater than 20; and R is a C1-C20 aliphatic or aromatic compound containing at least one hetero atom such as oxygen, sulfur, nitrogen or fluorine; or an active sulfur anode comprising sulfur solely, or a mixture of sulfur and a conductive material such as carbon. The polymer weo can be directly laminated on the electrode.

The polymer web thus prepared is laminated or rolled between cathode and anode and placed in the battery case, which is sealed into a battery after injection of an organic solvent electrolyte. Alternatively, the polymer web is integrated with the electrodes by the heat lamination process and sealed into a battery.

The organic solvent electrolyte used in the manufacture of a battery includes at least one selected from the group consisting of Li salt-dissolved EC(ethylene carbonate)-DMC (dimethyl carbonate) solution, Li salt-dissolved EC(ethylene carbonate)-DEC(diethyl carbonate) solution, Li salt-dissolved EC(ethylene carbonate)-EMC(ethylmethyl carbonate) solution, Li salt-dissolved EC(ethylene carbonate)-PC(propylene carbonate) solution, or a mixed solution of them, or a solution containing at least one component selected from the group consisting of methyl acetate (MA), methyl propionate (MP), ethyl acetate (EA), ethyl propionate (EP), butylene carbonate (BC), γ-butyrolactone (γ-BL), 1,2-Dimethoxyethane (DME), dimethylacetamide (DMAc) and tetrahydrofuran (THF), which are added in order to enhance the low temperature properties of the solution.

A process for forming an electrolyte layer for lithium secondary battery may be an in situ polymerization process. For example, an electrolyte layer prepared by an in situ polymerization of a monomer or PEO(polyethyleneoxide)-PPO(polypropyleneoxide)-acrylate has a poor mechanical strength and may include a unwoven fabric as a matrix. In this case, the unwoven fabric is immersed in the monomer solution for polymerization to prepare a polymer electrolyte layer having the thickness of the unwoven fabric. However, the existing unwoven fabric commercially available is a melt blown type, a web type linking fibers with an adhesive, or a sewn type linking fibers using a needle by a physical method. It is thus difficult to prepare a thin unwoven fabric because such a web is composed of fibers having a diameter of from several micrometers to several scores of micrometers.

The polymer web prepared by the electrospinning is preferable as a thin polymer electrolyte layer for secondary battery because its thickness is controllable. In addition, the polymer web has a fiber structure having a submicrometer-level thickness and hence a high uniformity of the web. In this aspect, the electrolyte layer prepared by polymerizing the monomer immersed in the polymer solution has the polymer uniformed distributed in the matrix and exhibits uniform properties.

Alternatively, the polymer web of the present invention is laminated directly on a filter medium such as a unwoven fabric or a filter paper to coat a thin fiber-structured polymer layer. As an air filter material for domestic or industrial uses, there is used a unwoven fabric or a filter paper. A more efficient filter includes HEPA filter and ULPA filter.

The HEPA filter includes a glass filter using glass fibers as a filter material and a non-glass filter using fluorine resin or quartz fibers. In most cases, glass fibers having a thickness of 0.3 to 0.5 μm and a length of 2 to 3 mm are distributed in water, dried on a fine net and processed in a paper form, in which case there is a problem in regard to technical difficulty and high production cost that result in expensiveness of the filter. Moreover, the need of replacement after an elapse of predefined time increases the maintenance expense.

The filtration efficiency is enhanced as if skin layers were formed, when a polymer web with fibers having a nanometer-level thickness is formed on the surface of a general filter paper using the electrospinning process according to the present invention. The same effect is also achieved through a second filtration of the polymer web through the unwoven fabric, in the case of forming the polymer web with fibers having a nanometer-level thickness on the surface of the unwoven fabric using the electrospinning process. To enhance the adhesiveness, a lamination step may be additionally performed.

With a general filter paper or a unwoven fabric placed on a collector or a conductive roller and subjected to the electrospinning process, a filter medium coated with the nanometer-level fiber-structure polymer web of the present invention can be prepared with a high efficiency at a low cost. The layer prepared by the electrospinning process has a high porosity and hence a low pressure loss caused by air entrance. This enables realization of a filter device with an excellent filtration characteristic and a high economic efficiency.

Accordingly, a high-value filter can be manufactured in a manner that a thin fiber-structured polymer web is laminated or coated in a skin form on an inexpensive filter medium such as unwoven fabric or filter paper. Furthermore, a plurality of polymer webs separately prepared are laminated on the filter medium to enhance the filtration efficiency.

### DETAILED DESCRIPTION OF THE PREFERRED EMBODIMENT

Hereinafter, a method for fabricating a thin fiber-structured polymer web will be described in more detail by way of the following examples, which are not intended to limit the scope of the present invention.

### EXAMPLE 1

80 g of N,N-dimethyl formamide and 20 g of polyacrylonitrile (Polyscience, molecular weight: 150,000) were added into a mixer and stirred at 40° C. for one hour to obtain a clear polymer solution.

The polymer solution was added into the barrel of an electrospinning device that had five multi-nozzles with 24 needles. The nozzles and the barrel were heated with a heating band to maintain the temperature of the polymer solution at 60° C. A high voltage of 10 kV was applied to the nozzles, the discharge rate of the polymer solution from the individual needle being 180 μl/min, the height from the nozzles to the collector being 20 cm. The collector was a grounded aluminum plate. The speed of the aluminum plate moving through a conveyer belt was 4 m/min. The relative humidity in the working room was 25%.

The high-porosity polymer web thus obtained was isolated from the aluminum plate and its layer thickness was measured with a micrometer calipers. The thickness of the polymer web was 50 μm. A TEM picture showed that the polymer web has a fiber structure. The polymer web thus obtained was used as an isolation layer for lithium secondary battery.

### Comparative Example 1

The procedures were performed in the same manner as described in Example 1, excepting that the temperature of the polymer solution was maintained at 25° C. The polymer web thus obtained was 40 μm in thickness and a TEM picture showed that the polymer web was not of a fiber structure but had a film structure in which fibers were entangled with liquid drops.

### EXAMPLE 2

70 g of N,N-dimethyl formamide and 10 g of dimethyl carbonate were added into a mixer. After adding 20 g of polyacrylonitrile, the mixture was stirred at 40° C. for one hour to obtain a clear polymer solution. The procedures were performed in the same manner as described in Example 1, excepting that the discharge rate of the polymer solution from the individual needle was 250 μl/min. The layer thickness of the polymer web as measured with a micrometer calipers was 67 μm. A TEM picture showed that the polymer web had a fiber structure.

### Comparative Example 2

The procedures were performed in the same manner as described in Example 1, excepting that the discharge rate of the polymer solution from the individual needle was 240 μl/min as in Example 2. The polymer web was 58 μm in thickness. A TEM picture showed that the polymer web had a film structure in which fibers were entangled with liquid drops.

### EXAMPLE 3

The procedures were performed in the same manner as described in Example 1. The electrospinning device as used herein was equipped with air knives around the multi-nozzle pack as shown in FIG. 8. The flux of air was 0.5 m/sec and the collector was a grounded copper web. Under the copper web moving through the conveyer belt was provided an air vent for the sake of ventilation of the volatilized solvent. The discharge rate of the polymer solution from the individual needle was 200 μl/min, which was greater than that in Example 1.

The high-porosity polymer web thus obtained was 53 μm in thickness. A TEM picture showed that the polymer web had a fiber structure.

### EXAMPLE 4

20 g of dimethylacetamide and 60 g of acetone were added into a mixer. After adding 20 g of polyvinylidene fluoride (Atochem, Kynar 761), the mixture was stirred at 70° C. for one hour to obtain a clear polymer solution. The polymer solution was added into the barrel of an electrospinning device that had twenty multi-nozzles with 24 needles. The nozzles and the barrel were heated with a heating band to maintain the temperature of the polymer solution at 50° C. The collector was a grounded lithium cathode and the height from the nozzles to the collector was 15 cm. A high voltage of 12 kV was applied to the nozzles to discharge the polymer solution onto the both sides of the lithium cathode at a predetermined discharge rate. The discharge rate of the polymer solution from the individual needle was 220 μl/min, and the speed of the lithium cathode moving through a conveyer belt was 20 m/min. The relative humidity in the working room was 19%.

The layer thickness of the high-porosity polymer web thus obtained was 44 μm as measured with a micrometer calipers.

### EXAMPLE 5

80 g of N,N-dimethyl formamide and 20 g of polyacrylonitrile were added into a mixer and stirred to obtain a clear polymer solution. The polymer solution was added into the barrel of an electrospinning device. The collector was a copper plate. The nozzles and the barrel were heated with a heating band to maintain the temperature of the polymer solution at 90° C. A voltage of 10 kV was applied to the nozzles to discharge the polymer solution onto the collector from a predetermined height and at a predetermined discharge rate, thereby obtaining a polymer web being about 90 μm thick.

The polymer web was processed into a carbon web through an oxidization furnace and a carbonization furnace.

### EXAMPLE 6

20 g of dimethylacetamide and 60 g of acetone were added into a mixer. After adding 20 g of polyacrylonitrile, the mixture was stirred to obtain a clear polymer solution. The polymer solution was added into the barrel of an electrospinning device. The height from the nozzles to the collector was 20 cm. A voltage of 18 kV was applied to the nozzles to discharge the polymer solution onto the collector at a predetermined discharge rate. A high-porosity polymer web having a thickness of about 30 μm was isolated from the collector. The porous polymer web thus obtained was immersed in a mixed solution prepared by uniformly mixing ethylene glycolethylcarbonate methacrylate, tri(ethylene glycol)dimethacrylate and 2-ethoxyethylacrylate, forming a film. The film thus obtained was then subjected to heat polymerization into a thin electrolyte layer for secondary battery that has a thickness of 30 μm and a high mechanical strength.

### EXAMPLE 7

The composition and the conditions for fabrication of a polymer web were the same as described in Example 4. The collector was a graphite cathode and the polymer solution was discharged on the both sides of the cathode to obtain a polymer web having a thickness of about 50 μm. The same procedures were performed to coat the one side of an LiCoO2 anode with a high-porosity fiber-structured polymer web having a thickness of about 50 μm. The both sides of the graphite cathode coated with the high-porosity polymer web was integrated with the side of the LiCoO2 anode coated with the high-porosity isolation layer through heating lamination, such that the coated sides are disposed in a face-to-face relationship with each other.

### EXAMPLE 8

The composition and the conditions for fabrication of a polymer web were the same as described in Example 4. An organodisulfide composite compound containing polyaniline was discharged onto a polycarbon sulfide compound anode used as a collector, to obtain an organodisulfide composite compound anode with a laminated fiber-structured polymer web having a thickness of about 50 μm.

### EXAMPLE 9

80 g of acetone and 20 g of polyvinylidene fluoride (Atochem, Kynar 761) were added into a mixer (solution A). 80 g of dimethylacetamide, 10 g of polyvinylidene fluoride (Atochem, Kynar 761) and 10 g of polyacrylonitrile (Polyscience, molecular weight: 150,000) were added into a mixer and stirred at 65° C. for 16 hours to obtain a clear polymer solution (solution B). 83 g of dimethylacetamide and 17 g of polyacrylonitrile were mixed to obtain a clear solution (solution C). These polymer solutions A, B and C were added into the barrel of an electrospinning device and respectively connected to three multi-nozzles equipped with 40 needles, and a voltage of 10 to 16 kV was applied to the nozzles. The height from the nozzles to the collector was 10 cm. The three multi-nozzles were connected in the order of the nozzle for solution A, the nozzle for solution B and the nozzle for solution C. The collector was a DMcT-polyaniline-polypyrrole-copper electrode and its moving speed was 20 m/min. The thickness of the porous polymer web thus obtained was about 60 μm as measured with a micrometer calipers.

### EXAMPLE 10

The procedures were performed in the same manner as described in Example 8, excepting that the collector was a graphite cathode. The polymer solution was discharged onto the both sides of the graphite cathode to obtain a high-porosity isolation layer having a thickness of about 50 μm.

### EXAMPLE 11

20 g of dimethylacetamide was mixed with 60 g of acetone with stirring. After adding 20 g of polyvinylidene fluoride (Atochem, Kynar 761), the mixture was stirred at 70° C. for 2 hours to obtain a clear polymer solution. In the same manner, after adding 20 g of polyacrylonitrile (Polyscience, molecular weight: 150,000), the mixture was stirred at 60° C. for 4 hours to obtain another clear polymer solution. These polymer solutions were individually added into the barrel of an electrospinning device. The height from the nozzles to the collector was 7 cm. A voltage of 15 kV was applied to the nozzles and each of the polymer solutions was discharged onto an anode comprising a mixture of a conductive composition and sulfur or carbon at a predetermined discharge rate to obtain a high-porosity polymer web having a thickness of about 50 μm.

### EXAMPLE 12

80 g of N,N-dimethylacetamide and 20 g of polyimide were added into a mixer and stirred at 30° C. for one hour to obtain a clear polymer solution. This polymer solution was added into the barrel of an electrospinning device. The collector was a copper rod. With a Resol Paper used as a filter placed on the copper rod, the nozzles and the barrel were maintained at 80° C. A voltage of 12 kV was applied to the nozzles and the polymer solutions was discharged onto the Resol paper from a predetermined height and at a predetermined discharge rate to obtain a high-porosity polymer web having a thickness of about 20 μm.

According to the present invention, the electrospinning process enables a high speed production of a porous and thin fiber-structured polymer web, which is applicable to various industrial fields, such as the isolation layer or the electrolytic layer for lithium-ion secondary battery, lithium-metal secondary battery or sulfur-based secondary battery, the isolation layer for fuel cells, filter, wound dressing, medical barrier web, medical scaffolder, sensors for MEMS/NEMS (micro-or nanoelectrical mechanical and optical systems, and so forth. If carbonated or graphitized, such a polymer web can also be used as a material for electrode materials or hydrogen storage medium, for localization of various equipment, substitution for imports and enlargement of export.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for preparing a thin fiber-structured polymer web, comprising the steps of:
dissolving a polymer in a volatile solvent used as a polymer solvent to prepare a polymer solution;
spinning the polymer solution by electrospinning; and
forming a thin fiber-structured polymer web cumulated on a collector.

2. The method as claimed in claim 1, wherein the volatile solvent is at least one having a high volatility selected from the group consisting of acetone, chloroform, ethanol, isopropanol, methanol, toluene, tetrahydrofuran, water, benzene, benzyl alcohol, 1,4-dioxane, propanol, carbon tetrachloride, cyclohexane, cyclohexanone, methylene chloride, phenol, pyridine, trichloroethane and acetic acid.

3. The method as claimed in claim 1, wherein the volatile solvent is a mixed solvent comprising at least one relatively high-volatility solvent and at least one relatively low-volatility solvent, the relatively high-volatility solvent being selected from the group consisting of acetone, chloroform, ethanol, isopropanol, methanol, toluene, tetrahydrofuran, water, benzene, benzyl alcohol, 1,4-dioxane, propanol, carbon tetrachloride, cyclohexane, cyclohexanone, methylene chloride, phenol, pyridine, trichloroethane and acetic acid, the relatively low-volatile solvent being selected from the group consisting of N,N-dimethyl formamide (DMF), dimethyl sulfoxide (DMSO), N,N-dimethylacetamide (DMAc), 1-methyl-2-pyrrolidone (NMP), ethylene carbonate (EC), propylene carbonate (PC), dimethyl carbonate (DMC), acetonitrile (AN), N-methylmorpholine-N-oxide, butylene carbonate (BC), 1,4-butyrolactone (BL), diethyl carbonate (DEC), diethylether (DEE), 1,2-dimethoxyethane (DME), 1,3-dimethyl-2-imidazolidinone (DMI), 1,3-dioxolane (DOL), ethyl methyl carbonate (EMC), methyl formate (MF), 3-methyloxazolidin-2-on (MO), methyl propionate (MP), 2-methyletetrahydrofurane (MeTHF) and sulpholane (SL).

4. The method as claimed in claim 1, wherein the relative humidity in a working space for the electrospinning is 0 to 40%.

5. The method as claimed in claim 1, wherein the temperature of the polymer solution during the electrospinning is in the range from 40° C. to the boiling point of the solvent.

6. The method as claimed in claim 1, wherein the content of the polymer used in the preparation of the polymer solution is 0.1 to 40 wt. % based on the content of the solvent.

7. The method as claimed in claim 1, wherein the polymer is selected from the group consisting of poly(vinylidene fluoride (PVDF), poly(vinylidene fluoride-co-hexafluoropropylene), polyacrylonitrile, poly(acrylonitrile-co-methacrylate), polymethylmethacrylate, polyvinylchloride, poly(vinylidenechloride-co-acrylate), polyethylene, polypropylene, nylon12, nylon-4,6, aramid, polybenzimidazole, polyvinylalcohol, cellulose, cellulose acetate, cellulose acetate butylate, polyvinyl pyrrolidone-vinyl acetates, poly(bis-(2-(2-methoxy-ethoxyethoxy))phosphazene) (MEEP), poly(propyleneoxide), poly(ethylene imide) (PEI), poly(ethylene succinate), polyaniline, poly(ethylene sulphide), poly(oxymethylene-oligo-oxyethylene), SBS copolymer, poly(hydroxy butyrate), poly(vinyl acetate), poly(ethylene terephthalate), poly(ethylene oxide), collagen, poly(lactic acid), poly(glycolic acid), poly(D,L-lactic-co-glycolic acid), polyarylates, poly(propylene fumalates), poly(caprolactone), biopolymer, coal-tar pitch, petroleum pitch, or copolymer of them, or blend of more than two of them.

8. The method as claimed in claim 7, wherein the polymer is mixed with an emulsion, or an organic or inorganic powder.

9. The method as claimed in claim 1, wherein the collector is an anode comprising at least one selected from the group consisting of LiCoO₂, LiMn₂O₂, LiMn₂O₄, LiNiO₂, LiCrO₂, LiVO₂, LiFeO₂, LiTiO₂, LiScO₂, LiYO₂, LiNiVO₄ LiNiCoO₂, V₂O₅ and V₆O₁₃; or a cathode comprising at least one selected from the group consisting of a carbon material including graphite, cokes or hard carbon, tin oxide, lithium compound of these materials, metal lithium and metal lithium alloy.

10. The method as claimed in claim 1, wherein the collector has its upper part provided with a filtering medium.

11. The method as claimed in claim 1, further comprising the step of compulsorily discharging air containing a large amount of the solvent to the outside while injecting air into the working space during the electrospinning.

12. A thin fiber-structured polymer web obtained by the method according to claim 1.

13. A filter obtained by laminating the thin fiber-structured polymer web manufactured by the method according to claim 1.
